(19) United States
(12) Patent Application Publication
(10) Pub. No.: US 2014/0229879 A1
(43) Pub. Date: Aug. 14, 2014

(54) TREEMAP VISUALIZATION SYSTEM AND METHOD

(71) Applicant: Ajou University Industry-Academic Cooperation Foundation, Suwon (KR)

(72) Inventors: Kyung Won LEE, Seoul (KR); Oh Hyun KWON, Suwon (KR); Jung Hong CHOI, Ansan (KR)

(73) Assignee: Ajou University Industry-Academic Cooperation Foundation, Suwon (KR)

(21) Appl. No.: 14/256,187

(22) Filed: Apr. 18, 2014

Related U.S. Application Data
(63) Continuation of application No. PCT/KR2012/008620, filed on Oct. 19, 2012.

(30) Foreign Application Priority Data
Oct. 20, 2011 (KR) 10-2011-0107452

(51) Int. Cl. G06F 17/30; G06F 3/0484; G06F 3/0481

(52) U.S. Cl. CPC G06F 17/30327; G06F 3/04815; G06F 3/04842
USPC 715/771; 707/797

(57) ABSTRACT

The present invention relates to a treemap visualization system and method, and more particularly, to a system and method which enables a user to control a visualized three-dimensional treemap with emphasis on a hierarchical structure, without distortion of the sizes of nodes. To this end, the treemap visualization system according to the present invention comprises a raw-data receiving unit, a node-region forming unit, and a node-region protrusion unit. The raw-data receiving unit receives raw data which contains a plurality of hierarchical nodes having weight values. The node-region forming unit forms node regions which are located on a convexly curved surface so as to correspond to the respective nodes. The node-region protrusion unit determines protrusion directions of the respective node regions such that the respective node regions do not overlap with each other, and protrudes the node regions by parallel translating the node regions in the determined protrusion directions.

### CROSS-REFERENCE TO RELATED APPLICATIONS

This application is a continuation of PCT/KR2012/008620 filed on Oct. 19, 2012, which claims priority to Korean Patent Application No. 10-2011-0107452 filed in the Korean Intellectual Property Office on Oct. 20, 2011, the entire contents of which are incorporated herein by reference.

### TECHNICAL FIELD

The present invention relates to a treemap control system and method, and more specifically, to a system and method, in which a user is allowed to control a three-dimensional treemap which is visualized by emphasizing a hierarchical structure, without distortion of a node size.

### BACKGROUND ART

With the advancement in information techniques, various hierarchical data can be confirmed from a wide range of databases including a forum, a mailing list, a business organization chart, a contents management category and a product category. A hierarchical structure, which is also referred to as a tree structure, is a set of a plurality of data nodes, in which all nodes except the topmost root node respectively have a single parent and zero or more child nodes. The hierarchical data include two kinds of information, i.e., structure information related to the hierarchical structure and contents information related to all of the nodes.

A treemap is one of methods of efficiently visualizing the hierarchical data. Unlike a conventional graph (a node-link diagram) illustrating a hierarchical structure in which most of space remains as an empty space, the treemap visualizes a large amount of hierarchical data through efficient use of the space in a method of filling a given display space without an empty space by recursively dividing a rectangle into a hierarchical structure as shown in FIG. 1(a). The area of each rectangle represents a weight of a node. For example, if files in a computer hard disk are visualized using a treemap, the hierarchical structure of directories is like a structure of recursively arranged rectangles, and the size of each file is represented as the area of each rectangle. The size of a directory is represented as a sum of the areas of rectangles representing internal files.

A detailed concept of the treemap is disclosed in a paper entitled “Tree-maps: A Space-Filling Approach to the Visualization of Hierarchical Information Structures” (Proc. IEEE Visualization '91, IEEE, Piscataway, N.J. (1991), 284-291) written by Brian Johnson and Ben Shneiderman.

A conventional treemap illustrates only external nodes as rectangles and represents internal nodes as a sum of the rectangles representing the external nodes. Like this, a treemap is limited in that it is difficult to identify a hierarchical structure since the internal nodes are not separately illustrated. Particularly, a research conducted by Van Wijk and Van de Wetering shows that such a limit is further clearly appeared when there are a lot of nodes and the hierarchical structure is balanced. As a result, the conventional treemap is almost unable to compare relative sizes, i.e., weights, of the nodes placed at different positions, and since it is difficult to figure out a hierarchical structure of information, there is a difficulty in the process of tracing an upper hierarchy of nodes.

In order to overcome such a limit, it is attempted to enhance visibility of a hierarchical structure in various studies, and one of the methods is a method of emphasizing a hierarchical structure by placing blank spaces between nodes.

However, unlike a conventional method in which all given areas are used to illustrate external nodes, this method cannot but represent an area of a node to be distorted since the space is consumed to illustrate a hierarchical structure, and, accordingly, there is a problem of representing a size of a node to be different from an actual weight. Furthermore, since the space is consumed to illustrate contents of nodes as shown in FIG. 1(b), the node areas are further distorted.

Another limit of the treemap is that information having a hierarchical structure is analyzed only as a metaphor of an ‘inclusion relation’. If a user recognizes a hierarchical structure as a form in which a parent node includes child nodes, there is no problem. However, if the user recognizes a hierarchical structure as a leveled structure of upper nodes and lower nodes, the shape of a treemap is difficult to understand. That is, since it is difficult to match the hierarchical structure and the treemap when the user recognizes the hierarchical structure, there is a problem in that the hierarchical structure of the treemap is difficult to understand.

Furthermore, there is a limit in controlling an implemented treemap as is intended by a user using a technique developed until present.

### SUMMARY OF THE DISCLOSURE

The present invention has been made keeping in mind the above problems occurring in the prior art, and an object of the present invention is to provide a system and method capable of visualizing a three-dimensional treemap by emphasizing a hierarchical structure without distortion of a node size.

Furthermore, an object of the present invention is to illustrate even information of a complex hierarchical structure having a lot of child nodes or a high order without distortion and allow a user to easily figure out the hierarchical structure.

Furthermore, an object of the present invention is to eliminate the need of providing a separate space for displaying node information.

Furthermore, an object of the present invention is to solve a cognitive problem of a conventional two-dimensional treemap and analyze a hierarchical structure as both an inclusion relation and a relation of higher or lower levels.

Furthermore, an object of the present invention is to allow a user to control an implemented treemap as is intended the user.

In order to achieve the above objects, a treemap visualization system in accordance with an embodiment of the present invention includes a processor within a computer system, the processor includes a raw data receiving unit, a node region forming unit and a node region protrusion unit. The raw data receiving unit receives raw data configured of a plurality of hierarchical nodes respectively having a weight value. The node region forming unit forms node regions positioned on a curved convex surface in correspondence to respective nodes. The node region protrusion unit determines protrusion directions of the node region so that the node regions may not overlap with each other and protrudes the node regions by moving the node regions in parallel in the determined protrusion directions.

In accordance with the present invention as described above, it is effective in that even information of a complex hierarchical structure having a lot of child nodes or a high order can be visualized indefinitely without distortion since an area of a node can be represented to correspond to an actual weight value without distortion.

Furthermore, since an empty space is naturally created between nodes, a hierarchical structure can be easily figured out.

In addition, since node information corresponding to each node region can be displayed on the side surface of each node using the space, it is effective in that a space for displaying the node information does not need to be separately created, and visibility of the hierarchical structure is further clarified.

Furthermore, since the cognitive problem of a conventional two-dimensional treemap is solved through a form of stacking nodes on a parent node, the hierarchical structure can be analyzed as both an inclusion relation and a relation of higher or lower levels.

Furthermore, since a control UI easy to use is provided to a user in controlling a display screen of a three-dimensional treemap, moving the screen to a region-of-interest of a node, or controlling the node to protrude or depress the node, highlight nodes of the same level and attribute and moving or adjusting the position or height of the node, an effect of utilizing the treemap is enhanced.

### BRIEF DESCRIPTION OF THE DRAWINGS

The above and other objects, features and advantages of the present invention will be more clearly understood from the following detailed description taken in conjunction with the accompanying drawings, in which:

FIGS. 1(a) through 1(c) are views visualizing nodes of a conventional treemap as a treemap;

FIG. 2 is a view schematically showing the configuration of a treemap visualization system in accordance with an embodiment of the present invention;

FIGS. 3(a) through 3(c) are views showing a process of forming node regions on a curved surface in correspondence to each node of a simple hierarchical structure;

FIGS. 4(a) through 4(d) are views showing a process of protruding each node based on the node regions formed in FIG. 3(c);

FIGS. 5(a) and 5(b) are views showing a result created through the steps of 4(a) to 4(d);

FIG. 6 is a view schematically showing the configuration of a treemap control system in accordance with an embodiment of the present invention;

FIG. 7 is a flowchart schematically illustrating the flow of a treemap visualization method in accordance with an embodiment of the present invention;

FIGS. 8(a) and 8(b) are views showing a process of forming node regions on a curved surface in correspondence to each node of a simple hierarchical structure;

FIG. 9 is a flowchart schematically illustrating the flow of a treemap control method in accordance with an embodiment of the present invention;

FIG. 10 is a view showing a screen of moving a region-of-interest of a node to the center in a three-dimensional treemap;

FIG. 11 is a screen showing a process of protruding and depressing a node in a three-dimensional treemap;

FIG. 12 is a screen showing a process of highlighting a node of the same level and the same attribute in a three-dimensional treemap;

FIG. 13 is a screen showing a process of moving a position of a node in a three-dimensional treemap; and

FIG. 14 is a screen showing a process of adjusting height of a node in a three-dimensional treemap.

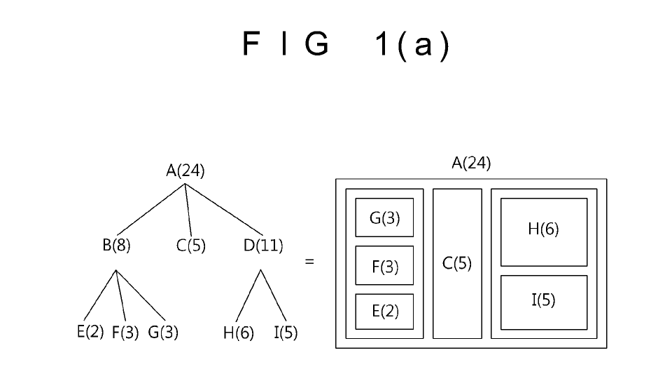

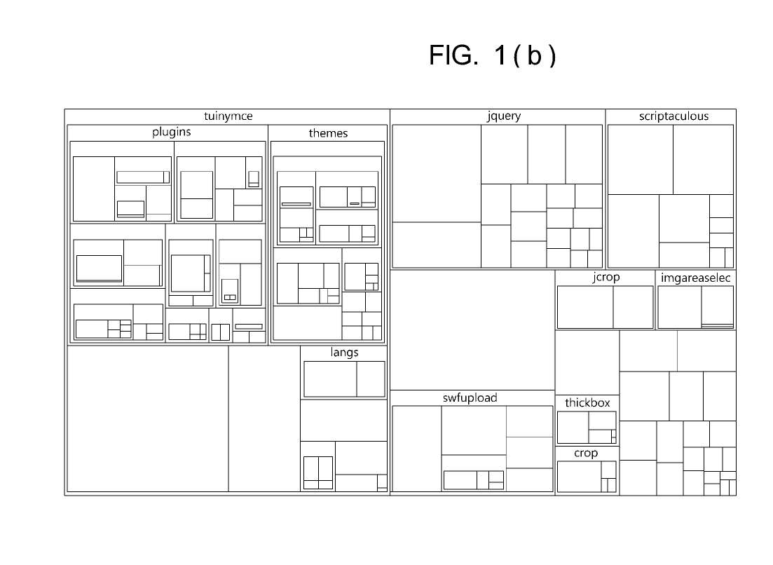

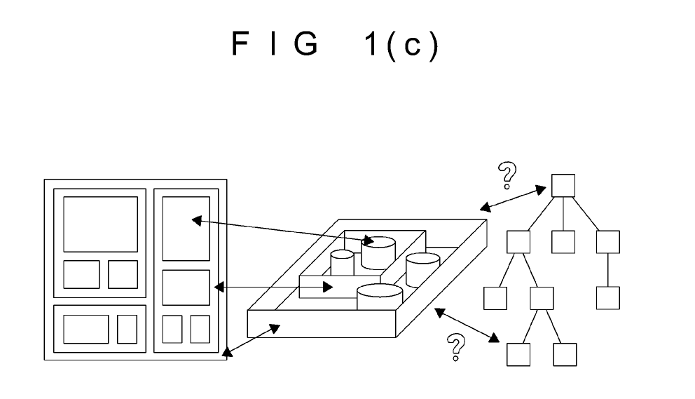

### DETAILED DESCRIPTION OF THE DISCLOSURE

In order to achieve the above objects, a treemap visualization system in accordance with an embodiment of the present invention includes a raw data receiving unit, a node region forming unit and a node region protrusion unit. The raw data receiving unit receives raw data configured of a plurality of hierarchical nodes respectively having a weight value. The node region forming unit forms node regions positioned on a curved convex surface in correspondence to respective nodes. The node region protrusion unit determines protrusion directions of the node region so that the node regions may not overlap with each other and protrudes the node regions by moving the node regions in parallel in the determined protrusion directions.

The preferred embodiments of the present invention will be hereafter described in detail with reference to the accompanying drawings. However, in describing the preferred embodiments of the present invention in detail, if already known configurations or specific description of functions related to the present invention may make the spirit of the present invention unclear, detailed description thereof will be omitted. In addition, in describing the embodiments of the present invention, specific numbers are merely an embodiment, and exaggerated numbers may be presented unlike a real case for the convenience and understanding of explanation.

<Description on Treemap Visualization System>

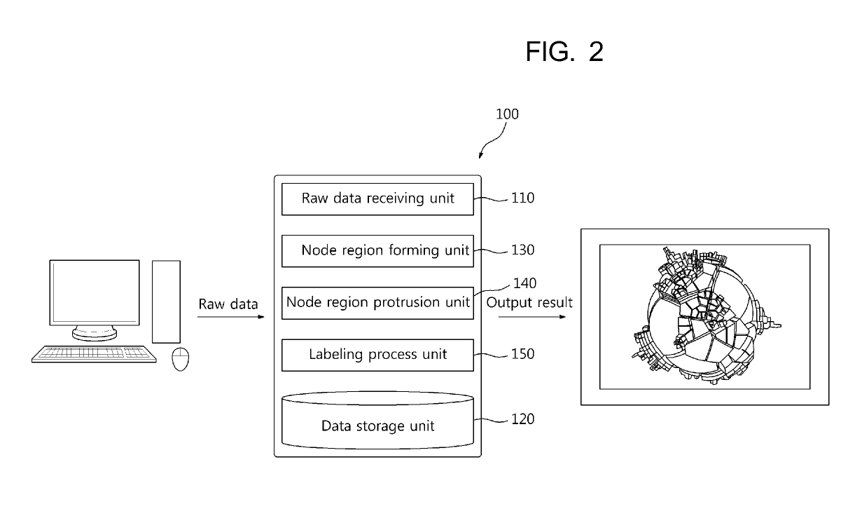

FIG. 2 is a view schematically showing the configuration of a treemap visualization system in accordance with an embodiment of the present invention;

Referring to FIG. 2, the treemap visualization system 100 in accordance with the present invention includes a raw data receiving unit 110, a data storage unit 120, a node region forming unit 130, a node region protrusion unit 140 and a labeling process unit 150.

The raw data receiving unit 110 receives raw data configured of a plurality of hierarchical nodes respectively having a weight value.

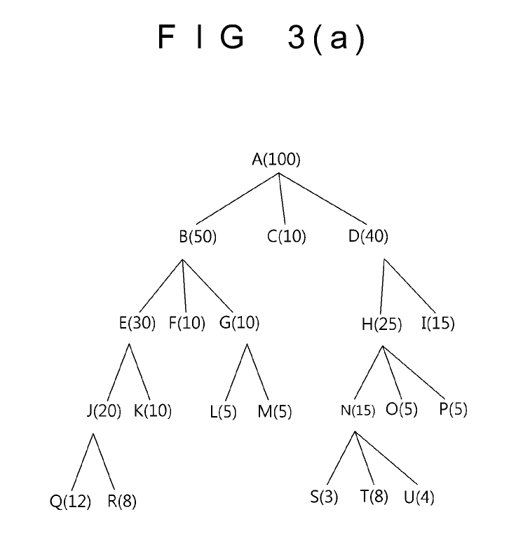

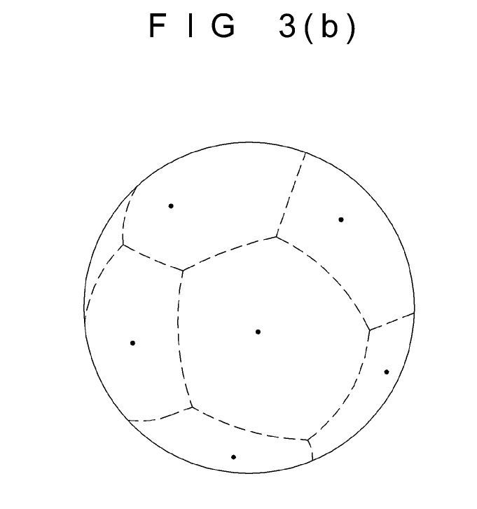

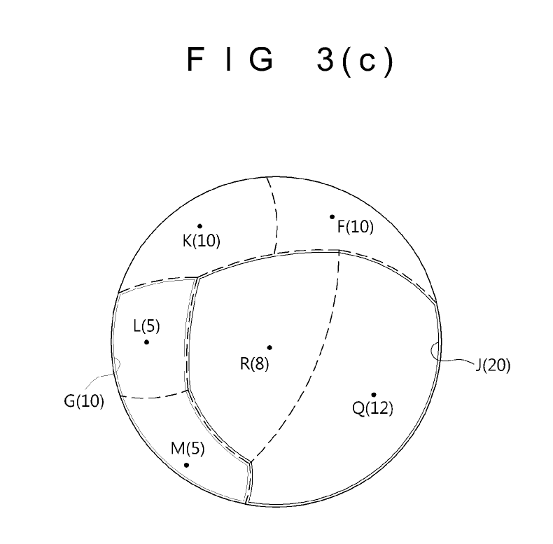

In the present invention, the raw data is data in which nodes are connected in a hierarchical (tree) structure starting from a node at the top level (a node that does not have a parent node), which is one of the nodes in the tree referred to as a root. Each node has information on a parent node (a node of a higher level, which connects certain nodes and has spawned the node), child nodes (nodes subordinate to a currently positioned node by one level) and sibling nodes (nodes having the same parent node) and a weight value, and the information is actually stored in the node in the hierarchical structure. Hereinafter, a simple hierarchical structure as shown in FIG. 3(a) will be described as an example for the convenience of explanation. In FIG. 3(a), the root is node A, and describing from the viewpoint of node B, the parent node is node A, the child nodes are nodes E, F and G, and the sibling nodes are nodes C and D, and the weight value of node B is 50.

The data storage unit 120 stores the raw data described above.

The node region forming unit 130 forms node regions positioned on a curved convex surface such as a sphere, a semi-sphere or the like in correspondence to respective nodes. That is, the node region forming unit 130 performs a function of forming node regions as shown in FIG. 3(c) by corresponding a nodes in the hierarchical structure shown in FIG. 3(a) to the curved surface, and a treemap is formed on a three-dimensional curved surface such as a sphere, and information thereon is stored in the data storage unit 120.

In order to form the node regions as shown in FIG. 3(c), first, it is assumed that the entire curved surface is a region of the root node, which is the top node, and node regions corresponding to respective nodes are formed by dividing the region on the curved surface into regions respectively corresponding to the child nodes of the root node. At this point, it may be configured such that an area of each node region may correspond to the weight value of the node based on a weight assigned to the node, and the weight value of each node may be visually recognized through an implementation like this.

Although various methods may be used as a method of forming the node regions, for example, a method of forming a reference point corresponding to each of the child nodes of the root node on a curved surface and forming a node region by assigning a region around the reference point may be used. In this case, it is possible to put a weight to each reference point and then assign a large region if the weight is large and assign a small region if the weight is small. In addition, through a process of assigning a region around a reference point, moving the reference point to the centroid of the assigned node region, and then assigning again a region, a region of a node can be formed to be similar to a regular polygon, and a region having an area corresponding to the weight value may be assigned. The visualization effect can be maximized through the process described above.

After assigning a node region to each of the child nodes of the root node as described above, the node region forming unit 130 may arrange child nodes of each node, for which a node region is formed, such that a node region of each of the child nodes may be formed within the node region of the parent node of the child node. In this method, node regions are formed for all the nodes including leaf nodes, which are bottom nodes.

A method of forming node regions of child nodes within the node region of the parent node may also be performed in the same manner as the method of setting node regions of child nodes of the root node described above. That is, reference points respectively corresponding to the child nodes are set within the node region of the parent node, and node regions of the child nodes may be arranged within the node region of the parent node by arranging a region around each of the reference points. In this case, a weight can be assigned to each reference point so that each node region may have an area corresponding to a weight value, and the area may be correctly represented and an effect of improving visualization may be expected through the method of moving the reference point to the centroid.

At this point, the node region may be illustrated in a variety of forms on an actual system, and the node regions may be modeled in a form similar to the curved surface using a large number of planar polygons, or the node region may be illustrated using a method such as Non-Uniform Rational B-Spline (NURBS) or the like which can illustrate a curved surface around a reference point. Any method capable of illustrating a node region located on a curved surface on a three-dimensional virtual space can be applied.

The leaf node described above is generally a node in which the number (order) of child nodes that the node has is zero or a node which does not have a subordinate branch, and in FIG. 3(a), Q, R, K, F, L, M, C, S, T, U, O, P and I are leaf nodes. Accordingly, thirteen reference points are created in correspondence to the leaf nodes, and node regions are formed while adjusting a region of an area to correspond to each of 12, 8, 10, 10, 5, 5, 10, 3, 8, 4, 5, 5 and 15, which are weight values of the nodes respectively, based on the thirteen reference points.

At this point, since each node has a weight value, it is preferable to determine an area occupied by each node on the curved surface to correspond to the weight value of the node and form a node region to have the determined area (see FIG. 3(b)). That is, the larger the weight value is, the larger the occupied node region is.

In addition, since child nodes are formed by splitting the node region of a parent node, if node regions of the child nodes are added, the added node region is the same as the node region of the parent node, and thus it is preferable to form node regions such that the node region of the parent node includes the node regions of the child nodes. Describing with reference to FIG. 3(a), node J, which is the parent node of nodes Q and R, has a weight value of 20 which is the sum of weight values of nodes Q and R. Accordingly, when the node regions are formed, a node region of node J is formed to include node regions of nodes Q and R, and in the same manner, node regions of other parent nodes are formed to include node regions of their child nodes.

Meanwhile, the node region protrusion unit 140 determines a protrusion direction of each node region such that adjacent node regions may not overlap with each other and protrudes each node region by moving the node region in parallel as much as a predetermined length in the determined protrusion direction. At this point, although leaf nodes are shown on the curved surface, the treemap may be three-dimensionally visualized by protruding node regions of all the nodes including parent nodes thereof. At this point, a desired result may be obtained by protruding child nodes always from the position of its parent node, not from the curved surface.

The direction of protruding each node region by the node region protruding unit 140 may be obtained through various methods, and if each node region is modeled through a plurality of small planar polygons, the direction of an average surface normal vector can be determined as a protrusion direction by obtaining an average of surface normal vectors of the small planar polygons. At this point, if areas of the small planar polygons are different from one another, it is preferable to use a weighted average vector which uses an area of a planar polygon as a weighting factor.

In addition, when the curved surface of the node region is implemented in a method such as the Non-Uniform Rational B-Spline (NURBS) or the like, the direction of the surface normal vector of a plane contacting with the curved surface at a reference point such as the centroid or the like of each node region can be selected as a protrusion direction. As described above, if a method of arranging a node region while moving the reference point to the centroid of each node region is used, an effect of confirming a protrusion direction can be obtained without separate additional calculation since the reference point of each node region corresponds to the centroid of the node region. A variety of methods other than this can applied, and only if the protrusion direction is formed in a direction that can prevent the protruded node regions from overlapping or contacting with each other, the hierarchical structure of the nodes may be visualized since gaps are created between node regions due to the protrusion, and the visual effect may be maximized since information can be displayed on a side surface formed owing to the protrusion.

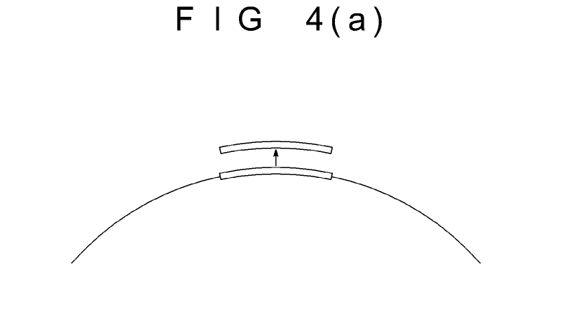

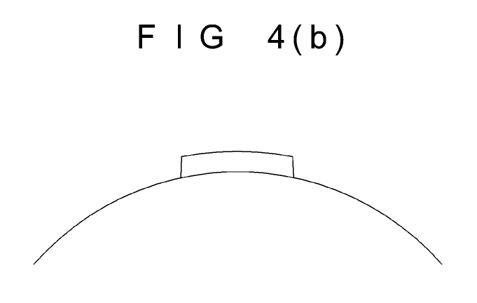

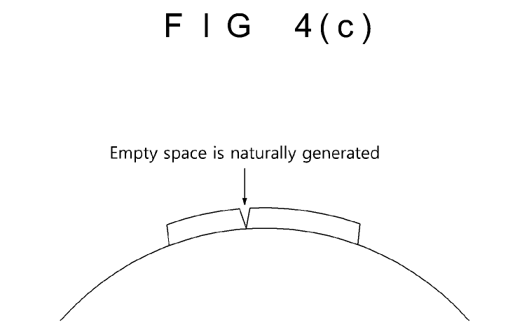

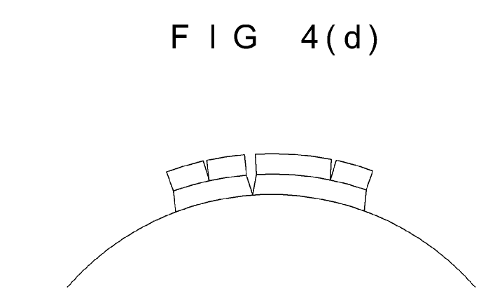

As described above, in the present invention, since a node region is moved in parallel in the protrusion direction in which node regions are not overlapped with each other in the process of protruding the node region, the node region does not grow although the order of the tree is increased, and an empty space is created between the nodes (see FIG. 4(c)).

In FIG. 3(a), since the node region of node B is formed to include nodes E, F and G, a protrusion direction of node B, which is a parent node, is determined first in order to protrude the node region of node B, and the node region of node B is protruded by moving the curved surface illustrating the node region of node B in parallel in the protrusion direction. In addition, node regions of nodes E, F and G, which are child nodes, are protruded from the node region of node B in a method as described above, and a three-dimensional treemap can be implemented by applying this method to all of the nodes.

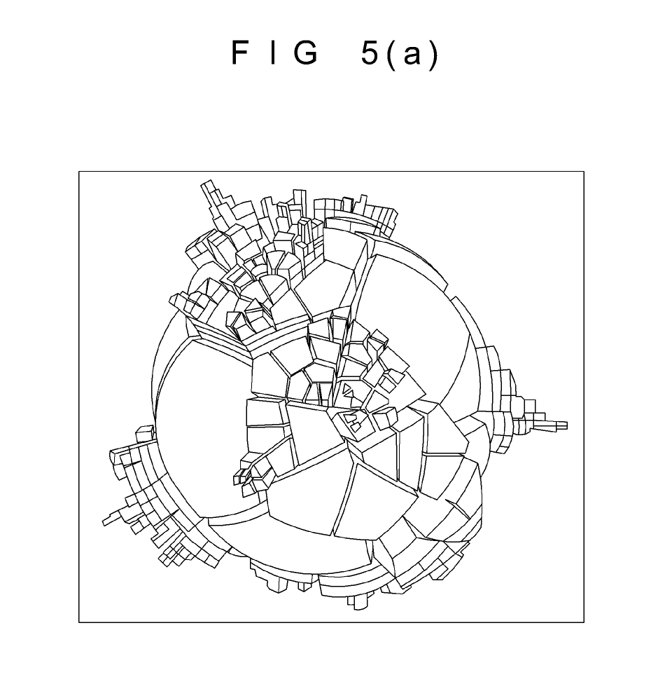

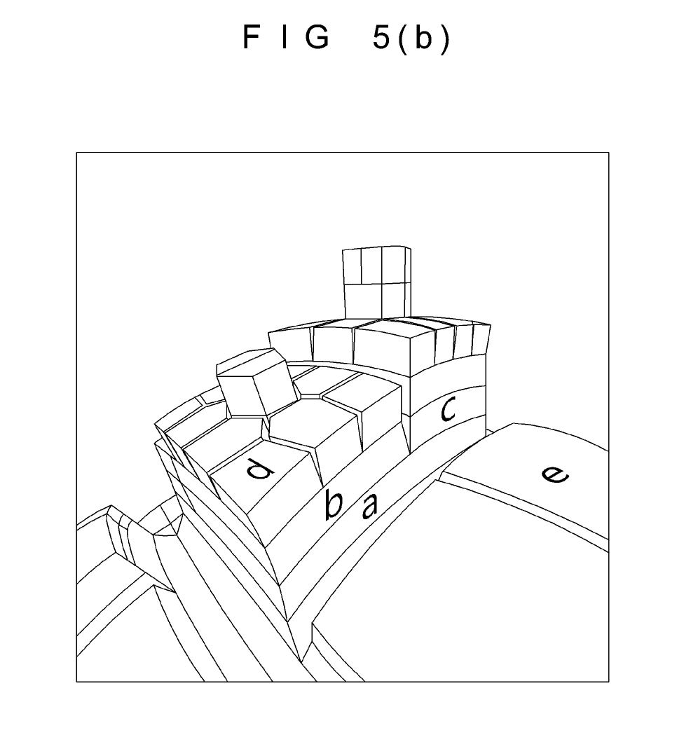

Like this, in order to implement a three-dimensional treemap on a curved surface, the labeling process unit 150 forms a side surface of the node region moved in parallel and displays node information corresponding to the node region on the side surface. For example, if a representative surface normal vector of a certain node region corresponding to the certain node is obtained, the node region protrusion unit 140 moves the certain node region in parallel in the protrusion direction of the node region as shown in FIG. 4(a), and the labeling process unit 150 forms a side surface of the certain node region moved in parallel as shown in FIG. 4(b). In this method, the node region protrusion unit 140 and the labeling process unit 150 form all node regions of a level the same as that of the certain node on the curved surface as shown in FIG. 4(c). If child node regions are protruded on parent node regions in such a manner as shown in FIG. 4(d), the treemap is three-dimensionally visualized and, in addition, empty spaces are formed between the nodes as shown in FIG. 5(a), and accordingly, node information may be displayed on the side surfaces formed between the nodes as shown in FIG. 5(b).

As a result, the three-dimensional treemap in accordance with the present invention has a structure of pushing each node region in a protrusion direction determined for each node and then stacking the node regions on the parent node. That is, it is configured in a form of stacking three-dimensional figures of a three-dimensional block shape on the surface of a sphere.

If this method is used, it is effective in that even information of a complex hierarchical structure having a lot of child nodes or a high order can be visualized indefinitely without distortion since an area of a node can be represented to correspond to an actual weight value without distortion. Furthermore, since an empty space is naturally created between nodes, the hierarchical structure can be easily figured out. In addition, since node information corresponding to each node region can be displayed on the side surface of each node using the space, it is effective in that a space for displaying the node information does not need to be separately created, and visibility of the hierarchical structure is further clarified. Furthermore, since the cognitive problem of a conventional two-dimensional treemap is solved through a form of stacking nodes on a parent node, the hierarchical structure can be analyzed as both an inclusion relation and a relation of higher or lower levels.

Meanwhile, if raw data are changed in the present invention, it is preferable to reconfigure in real-time the node regions arranged in FIG. 3(c). That is, reference points corresponding to respective leaf nodes are re-created on the curved surface according to the changed raw data, and node regions are reconfigured based on the re-created reference points to form a region of an area corresponding to the weight value of each of the changed nodes. Like this, since the node regions can be reconfigured by promptly reflecting information on the changed raw data to the three-dimensional treemap, the treemap visualization system 100 in accordance with the present invention may have high reliability.

<Description on Treemap Control System>

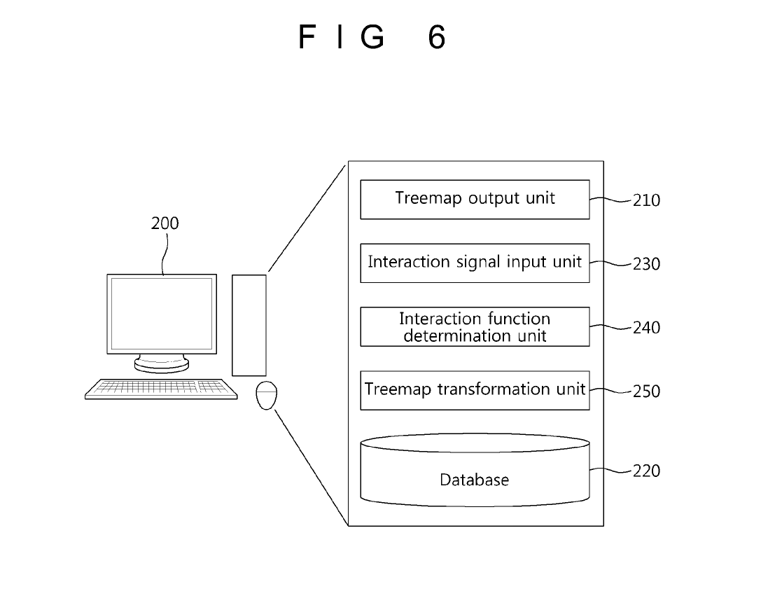

FIG. 6 is a view schematically showing the configuration of a treemap control system in accordance with an embodiment of the present invention.

Referring to FIG. 6, the treemap control system 200 in accordance with the present invention includes a treemap output unit 210, a database 220, an interaction signal input unit 230, an interaction function determination unit 240 and a treemap transformation unit 250.

The treemap output unit 210 receives raw data configured of a plurality of hierarchical nodes respectively having a weight value and outputs a three-dimensional treemap which protrudes node regions respectively corresponding to the nodes on a curved convex surface. Since the implementation method and form of the three-dimensional treemap are described above in detail, descriptions thereof will be omitted.

The database 220 is a configuration for storing attribution information of the nodes contained in the raw data, and the attribute information is information needed for forming a node region on the three-dimensional curved surface, such as a node level, a weight value, position information, height information, a time of changing the node information and the like.

The interaction signal input unit 230 receives an interaction signal from a user. In the present invention, the interaction signal is a signal which allows a user to zoom in or zoom out a display screen of a general PC or a terminal, such as a cellular phone, a PDA, a smart phone, a tablet PC or the like, for outputting the three-dimensional treemap in a method of dragging a mouse wheel or a mouse, or the interaction signal is a signal which allows a user to change the shape of the three-dimensional treemap by selecting a node from the three-dimensional treemap, and moving position and adjusting height of the node in a method of mouse click or touch.

When an interaction signal is input, the interaction function determination unit 240 determines an interaction function corresponding to the stored attribute information and the interaction signal input. In the present invention, the interaction function is a function of zooming in or zooming out the display screen of a three-dimensional treemap corresponding to the interaction signal described above or a function of changing the shape of a three-dimensional treemap by selecting a node from the three-dimensional treemap and moving position and adjusting height of the node.

Hereinafter, the interaction function will be described in further detail.

The interaction function of the present invention may be divided into a display screen control function, a moving-to region-of-interest (rotating/panning) function, and a node control function of a three-dimensional treemap. The node control function may be divided into node protrusion and depression (peeling-off and stacking-up), highlighting nodes of the same level and the same attribute (Structure-based Highlighting and Attribute-based Highlighting) and movement and adjustment of position and height of a node (Node Position/Node Height).

First, the display screen control function is a function capable of zooming in and zooming out the display screen of the three-dimensional treemap through a UI of dragging a mouse while pressing the mouse wheel or the right button of the mouse, and the size of node information labeled on the side surface between nodes is also changed according to the zoom amount.

Next, the moving-to region-of-interest function is a function set in correspondence to an interaction signal for moving to a region-of-interest in the three-dimensional treemap. An example of this function is a function of rotating the three-dimensional treemap through a means of mouse click or touch so that a user may see a region-of-interest of the three-dimensional treemap. Another example is a panning function in which it is shown as if the three-dimensional treemap is fixed to the display screen and a background screen moves instead.

In a movement relation between a moving subject and a fixed background screen, panning is generally a technique of photographing as if the moving subject is fixed to the screen and the background screen moves instead. In most cases, such panning is a technique of setting a camera to low speed photography and photographing the subject while moving at a speed the same as that of a running vehicle or athlete, and this is frequently used to obtain an image having a feeling of speed owing to the photographing technique of fixing a moving subject and changing a background.

However, since only an empty screen may be shown if a user using such a panning technique moves toward an unintended position or in a wrong direction, the panning function of the present invention allows the user to select nodes and then move to a region-of-interest with respect to the selected nodes in order to solve this problem.

Finally, the node control function is a function set in correspondence to an interaction signal for controlling a node selected by the user, and specifically, this is a function capable of selecting a node, protruding and depressing the node, highlighting the node, and moving and adjusting position and height of the node. It is preferable that the functions described above are performed after the user selects options appropriate to the functions for the convenience of use.

Meanwhile, the interaction function determination unit 240 determines a function corresponding to an interaction signal for moving to a region-of-interest based on the set moving-to region-of-interest function and determines a function corresponding to an interaction signal of the selected node based on the set node control function.

The treemap transformation unit 250 transforms the three-dimensional treemap output to the treemap output unit 210 according to the determined function.

Hereinafter, in relation to the interaction functions described above, the interaction function determination unit 240 and the treemap transformation unit 250 will be described in more detail.

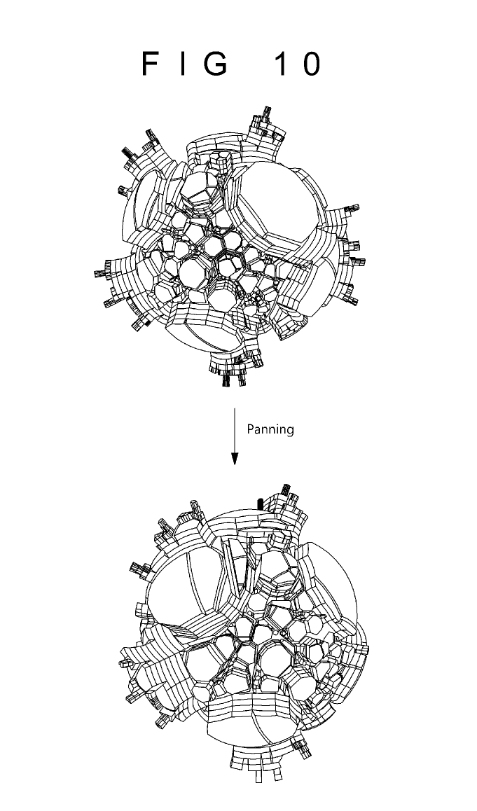

In relation to the panning of the moving-to region-of-interest function, the interaction function determination unit 240 selects a plurality of nodes based on the set moving-to region-of-interest function and then determines a function corresponding to an interaction signal for selecting a region-of-interest from the three-dimensional treemap based on the selected node, and the treemap transformation unit 250 positions the selected region-of-interest at the center of the display screen as shown in FIG. 10 according to the determined function.

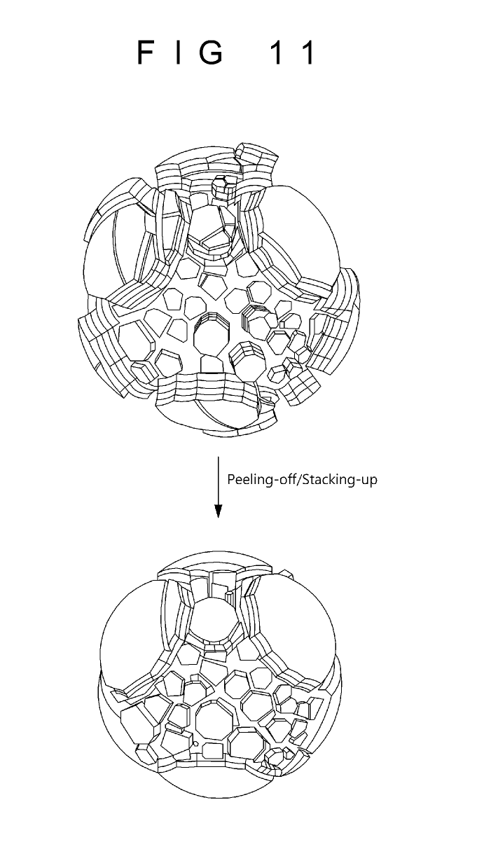

In relation to the node protrusion and depression of the node control function, the interaction function determination unit 240 determines a function corresponding to an interaction signal for determining protrusion and depression of one or more selected node regions based on the set node control function, and the treemap transformation unit 250 protrudes or depresses the selected node regions as shown in FIG. 11 according to the determined function. Accordingly, the user may protrude or depress a specific node, for example, a certain node selected by the user, or nodes having the same level.

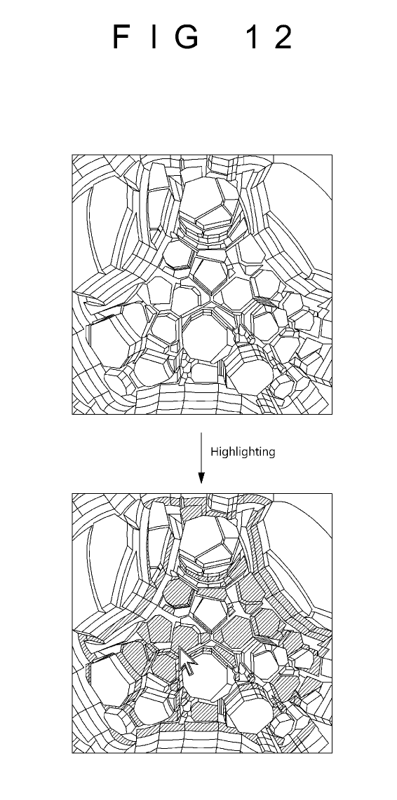

In relation to the highlighting nodes of the same level and the same attribute, the interaction function determination unit 240 determines a function corresponding to an interaction signal for highlighting one or more nodes having the same level or attribute information as that of a selected node based on the set node control function and attribute information of the nodes, and the treemap transformation unit 250 highlights the nodes having the same level or attribute information (e.g., a weight value and a time of changing the node) according to the determined function. The object of the highlight function is to indicate a set of hierarchical nodes, and in the present invention, it is implemented to highlight a node if the user moves a mouse cursor onto the node. At this point, it may be implemented to increase only brightness while maintaining the hue and the saturation of the highlighted node as shown in FIG. 12, and the present invention is not limited by such a specific implementation method.

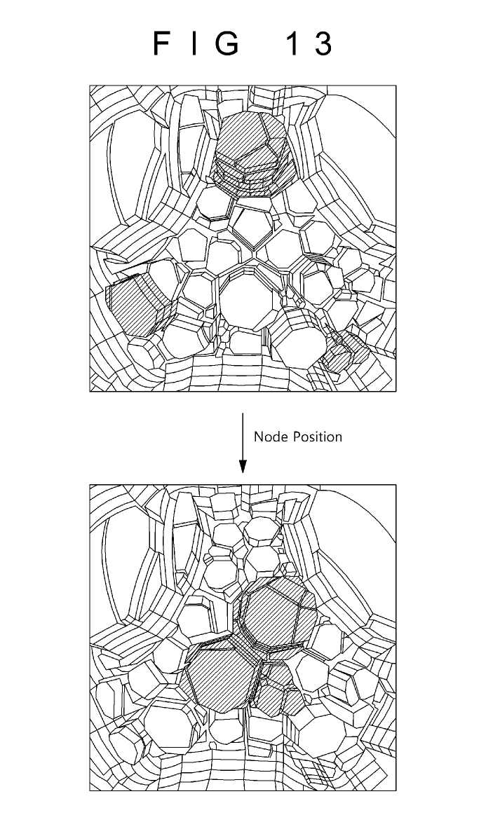

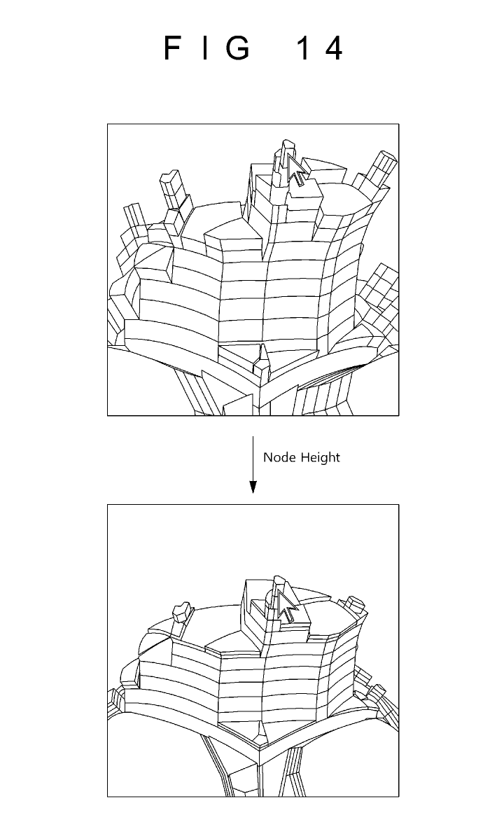

In relation to the movement and adjustment of position and height of a node of the node control function, the interaction function determination unit 240 determines a function corresponding to an interaction signal for adjusting position and height of one or more selected nodes based on the set node control function and attribute information of the nodes, and the treemap transformation unit 250 changes the position and height of the selected nodes as shown in FIG. 13 according to the determined function. Moving the position of a node is useful when weight values or levels of two nodes are visually compared, such as comparing a specific node with another node spaced apart from the specific node by the user, and it simply needs to move either of the two nodes so as to be adjacent to each other by clicking and dragging the mouse. Since update of node information according to the movement of position of the node is performed based on a Voronoi diagram, the update may be accomplished stably. In addition, since the object of adjusting the height of a node is to put emphasis on highlighted or selected nodes, in this case, it only needs to select the nodes and increase height of the nodes or select the other nodes and decrease height of the nodes.

As described above, since a control UI easy to use is provided to a user in controlling a display screen of a three-dimensional treemap, moving the screen to a region-of-interest of a node, or controlling the node to protrude or depress the node, highlight nodes of the same level and attribute and moving or adjusting the position or height of the node, an effect of utilizing the treemap is enhanced.

<Description on Treemap Visualization Method>

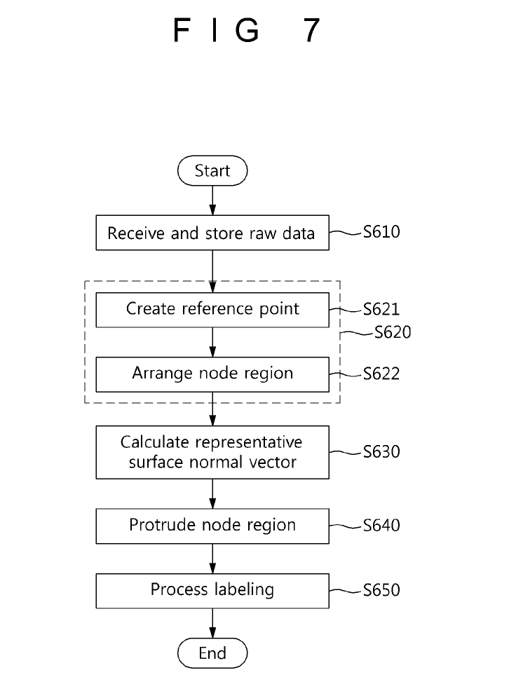

A treemap visualization method in accordance with an embodiment of the present invention is described with reference to the flowchart shown in FIG. 7, and this will be described by attaching sequence numbers for the sake of convenience.

1. Raw Data Receiving and Storing Step <610>

Raw data configured of a plurality of hierarchical nodes respectively having a weight value is received and stored, and the raw data in the present invention is the same as described above, description thereof will be omitted.

2. Node Region Forming Step <620>

This is a step of forming node regions positioned on a curved convex surface such as a sphere, a hemisphere or the like in correspondence to respective nodes, in which an area occupied by a node on the curved surface is determined to correspond to a weight value of the node, and a node region is formed to have the determined area. Various methods may be applied as a method of forming the node regions, and an embodiment described below can be applied.

2-1. Reference Point Creation Step <621>

Reference points corresponding to respective nodes are created on the curved surface.

2-2. Node Region Arranging Step <622>

A region of an area corresponding to a weight value of each node is dynamically formed based on each reference point. The reference points are given on the curved surface at step S621, and corresponding node regions are obtained by dividing the given curved surface to be suitable for the reference points. In order to have the area of the obtained node region correspond to the weight value, a weight is assigned to a reference point, and a large region is assigned if the weight is large, and a small region is assigned if the weight is small. In addition, it is preferable to form a region of a node to be similar to a regular polygon by repeating the process of moving the reference point to the centroid of the obtained region and assign the region an area appropriate to the weigh value.

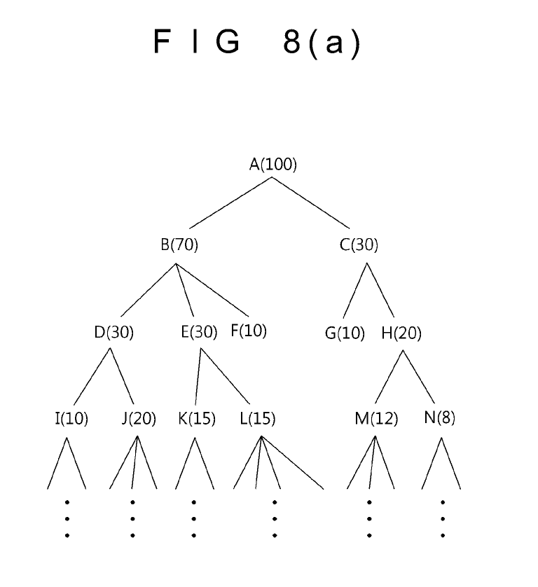

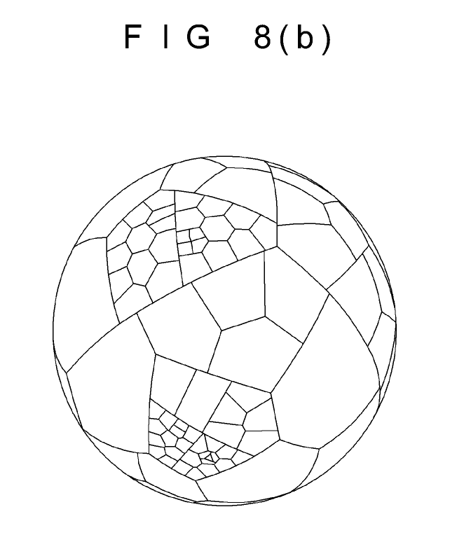

In addition, since child nodes are formed by splitting the node region of a parent node, if node regions of the child nodes are added, the added node region is the same as the node region of the parent node, and thus it is preferable to form node regions such that the node region of the parent node includes the node regions of the child nodes. As a result, node regions corresponding to respective leaf nodes in the hierarchical structure as shown in FIG. 8(a) may be formed on the curved surface as shown in FIG. 8(b).

3. Protrusion Direction Determination Step <S630>

A direction in which each node region can be protruded without overlapping or contacting with adjacent node regions is determined as a protrusion direction of the node region, and a method described below may be used to obtain the direction.

First, if a node region is configured of a plurality of small planar polygons, the direction of an average surface normal vector can be determined as a protrusion direction by obtaining an average of surface normal vectors of the polygons. At this point, if areas of the small planar polygons are different from one another, it is preferable to use a weighted average vector which uses an area of a planar polygon as a weighting factor.

In addition, when the curved surface of the node region is implemented in a method such as the Non-Uniform Rational B-Spline (NURBS) or the like, the direction of the surface normal vector of a plane contacting with the curved surface at a reference point such as the centroid or the like of each node region can be selected as a protrusion direction. As described above, if a method of arranging a node region while moving the reference point to the centroid of each node region is used, an effect of confirming a protrusion direction can be obtained without separate additional calculation since the reference point of each node region corresponds to the centroid of the node region.

4. Node Region Protrusion Step <S640>

The node region is protruded by moving the node region in parallel in the direction of the representative surface normal vector. In the present invention, node regions are protruded in a preorder traversal method, in which a node region of a parent node is protruded first, and then node regions corresponding to child nodes of the parent node are protruded (see FIG. 4).

5. Labeling Process Step <S650>

A side surface of the node region moved in parallel is formed at step S640, and node information corresponding to the node region is displayed on the side surface.

If child node regions are protruded on parent node regions in such a manner, the treemap is three-dimensionally visualized and, in addition, empty spaces are formed between the nodes as shown in FIG. 5(a), and, accordingly, node information may be displayed on the side surfaces formed between the nodes as shown in FIG. 5(b).

As a result, the three-dimensional treemap in accordance with the present invention has a structure of pushing each node region in a protrusion direction and then stacking node regions on a parent node, and thus it is configured in a form of stacking three-dimensional figures of a three-dimensional block shape on the surface of a sphere.

If this method is used, it is effective in that even information of a complex hierarchical structure having a lot of child nodes or a high order can be visualized indefinitely without distortion since an area of a node can be represented to correspond to an actual weight value without distortion. Furthermore, since an empty space is naturally created between nodes, the hierarchical structure can be easily figured out. In addition, since node information corresponding to each node region can be displayed on the side surface of each node using the space, it is effective in that a space for displaying the node information does not need to be separately created, and visibility of the hierarchical structure is further clarified. Furthermore, since the cognitive problem of a conventional two-dimensional treemap is solved through a form of stacking nodes on a parent node, the hierarchical structure can be analyzed as both an inclusion relation and a relation of higher or lower levels.

Meanwhile, if the raw data are changed while the steps of the present invention are progressed, it is preferable to reconfigure in real-time the node regions arranged in FIG. 8(b). That is, reference points corresponding to respective nodes are re-created on the curved surface according to the changed raw data, and the node regions are reconfigured based on the re-created reference points to form a region of an area corresponding to the weight value of each of the changed nodes. Like this, since the node regions can be reconfigured by promptly reflecting information on the changed raw data to the three-dimensional treemap, reliability of the treemap visualization system 100 may be enhanced.

<Description on Treemap Control Method>

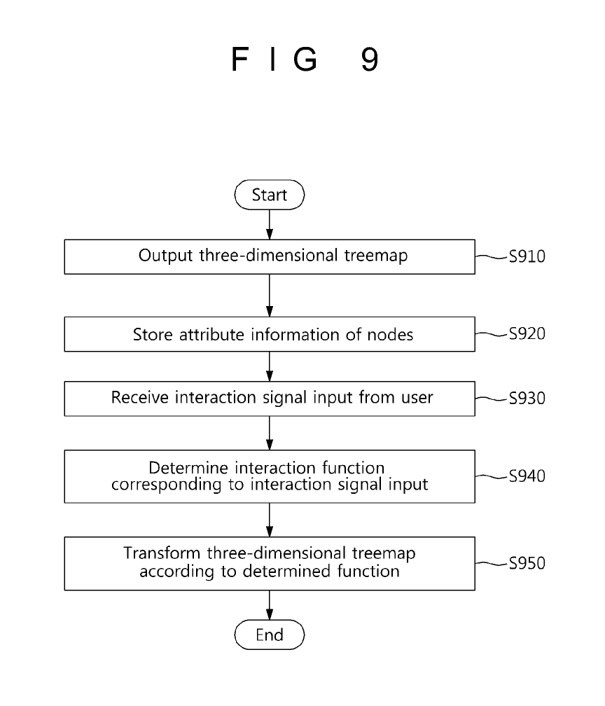

A treemap control method in accordance with an embodiment of the present invention will be described with reference to the flowchart shown in FIG. 9 and exemplary views shown in FIGS. 10 to 13, and this will be described by attaching sequence numbers for the sake of convenience.

1. Output Three-Dimensional Treemap <S910>

Raw data configured of a plurality of hierarchical nodes having a weight value is received, and a three-dimensional treemap which protrudes node regions respectively corresponding to the nodes on a curved convex surface is output. Since the implementation method and form of the three-dimensional treemap are described above in detail, descriptions thereof will be omitted.

2. Store Attribute Information of Nodes <S920>

This is a step of storing attribution information of the nodes contained in the raw data at step S910, and the attribute information is information needed for forming a node region on the three-dimensional curved surface, such as a node level, a weight value, position information, height information, a time of changing the node information and the like.

3. Receive Interaction Signal Input from User <S930>

An interaction signal is received from a user. In the present invention, the interaction signal is a signal which allows a user to zoom in or zoom out a display screen of a general PC or a terminal, such as a cellular phone, a PDA, a smart phone, a tablet PC or the like, for outputting the three-dimensional treemap in a method of dragging a mouse wheel or a mouse, or the interaction signal is a signal which allows a user to change the shape of the three-dimensional treemap by selecting a node from the three-dimensional treemap, and moving position and adjusting height of the node in a method of mouse click or touch.

4. Determine Interaction Function Corresponding to Interaction Input Signal <S940>

When an interaction signal is input, an interaction function corresponding to the stored attribute information and the interaction signal input is determined. The interaction function of the present invention may be divided into a display screen control function, a moving-to region-of-interest (rotating/panning) function, and a node control function of a three-dimensional treemap. The node control function may be divided into node protrusion and depression (peeling-off and stacking-up), highlighting nodes of the same level and the same attribute (Structure-based Highlighting and Attribute-based Highlighting) and movement and adjustment of position and height of a node (Node Position/Node Height).

First, the display screen control function is a function capable of zooming in and zooming out the display screen of the three-dimensional treemap through a UI of dragging a mouse while pressing the mouse wheel or the right button of the mouse, and the size of node information labeled on the side surface between nodes is also changed according to the zoom amount.

Next, the moving-to region-of-interest function is a function set in correspondence to an interaction signal for moving to a region-of-interest in the three-dimensional treemap. An example of this function is a function of rotating the three-dimensional treemap through a means of mouse click or touch so that a user may see a region-of-interest of the three-dimensional treemap. Another example is a panning function in which it is shown as if the three-dimensional treemap is fixed to the display screen and a background screen moves instead.

Generally, in a movement relation between a moving subject and a fixed background screen, panning is a technique of photographing as if the moving subject is fixed to the screen and the background screen moves instead. In most cases, such panning is a technique of setting a camera to low speed photography and photographing while moving at a speed the same as that of a running vehicle or athlete, and this is frequently used to obtain an image having a feeling of speed owing to the photographing technique of fixing a moving subject and changing a background.

However, since only an empty screen may be shown if a user using such a panning technique moves toward an unintended position or in a wrong direction, the panning function of the present invention allows the user to select nodes and then move to a region-of-interest with respect to the selected nodes in order to solve this problem.

Finally, the node control function is a function set in correspondence to an interaction signal for controlling a node selected by the user, and specifically, this is a function capable of selecting a node, protruding and depressing the node, highlighting the node, and moving and adjusting position and height of the node. It is preferable that the functions described above are performed after the user selects options appropriate to the functions for the convenience of use.

Meanwhile, a function corresponding to an interaction signal for moving to a region-of-interest is determined based on the set moving-to region-of-interest function, and a function corresponding to an interaction signal of the selected node is determined based on the set node control function.

5. Transform Three-Dimensional Treemap According to Determined Function <S950>

The three-dimensional treemap output at step S910 is transformed according to the function determined at step S940.

Hereinafter, steps S940 and S950 described above according to the interaction signals will be described in more detail.

In relation to the panning of the moving-to region-of-interest function, at step S940, a plurality of nodes is selected based on the set moving-to region-of-interest function, and then a function corresponding to an interaction signal for selecting a region-of-interest from the three-dimensional treemap is determined based on the selected node, and at step S950, the selected region-of-interest is positioned at the center of the display screen as shown in FIG. 10 according to the determined function.

In relation to the node protrusion and depression of the node control function, at step S940, a function corresponding to an interaction signal for determining protrusion and depression of one or more selected node regions is determined based on the set node control function, and at step S950, the selected node regions are protruded or depressed as shown in FIG. 11 according to the determined function. Accordingly, the user may protrude or depress a specific node, for example, a certain node selected by the user, or nodes having the same level.

In relation to the highlighting nodes of the same level and the same attribute, at step S940, a function corresponding to an interaction signal for highlighting one or more nodes having the same level or attribute information as that of a selected node is determined based on the set node control function and attribute information of the nodes, and at step S950, the nodes having the same level or attribute information (e.g., a weight value and a time of changing the node) are highlighted according to the determined function. The object of the highlight function is to indicate a set of hierarchical nodes, and in the present invention, it is implemented to highlight a node if the user moves a mouse cursor onto the node. At this point, it may be implemented to increase only brightness while maintaining the hue and the chroma of the highlighted node as shown in FIG. 12, and the present invention is not limited by such a specific implementation method.

In relation to the movement and adjustment of position and height of a node of the node control function, at step S940, a function corresponding to an interaction signal for adjusting position and height of one or more selected nodes is determined based on the set node control function and attribute information of nodes, and at step S950, the position and height of the selected nodes are changed according to the determined function as shown in FIG. 13. Moving the position of a node is useful when weight values or levels of two nodes are visually compared, such as comparing a specific node with another node spaced apart from the specific node by the user, and it simply needs to move either of the two nodes so as to be adjacent to each other by clicking and dragging the mouse. Since update of node information according to the movement of position of the node is performed based on a Voronoi diagram, the update may be accomplished stably. In addition, since the object of adjusting the height of a node is to put emphasis on the highlighted or selected nodes, in this case, it only needs to select nodes and increase height or select the other nodes and decrease height.

As described above, since a control UI easy to use is provided to a user in controlling a display screen of a three-dimensional treemap, moving the screen to a region-of-interest of a node, or controlling the node to protrude or depress the node, highlight nodes of the same level and attribute and moving or adjusting the position or height of the node, an effect of utilizing the treemap is enhanced.

The treemap control method in accordance with an embodiment of the present invention can be implemented in the form of a program executable by various computer means, and can be stored in a computer-readable recording medium. The computer-readable medium can include a program, a data file, a data structure, etc. solely or in combination. Meanwhile, the program recorded on the recording medium may have been specially designed and configured for the present invention, or may be known to those skilled in computer software. The computer-readable recording medium includes a hardware device specially configured to store and execute the program, such as a magnetic medium such as a hard disk, a floppy disk, and a magnetic tape, an optical medium such as a CD-ROM or DVD, or a magneto-optical medium, such as a floptical disk, ROM, RAM, or flash memory. Furthermore, the program may include both machine-language code, such as code written by a compiler, and high-level language code, which is executable by a computer using an interpreter. The hardware device can be configured in the form of one or more software modules for executing the operation of the present invention, and the vice versa

As described above, although the embodiments of the present invention have been described in connection with specific matters, such detailed elements, and the limited embodiments and drawings, they are provided only to help general understanding of the present invention, and the present invention is not limited to the embodiments. A person having ordinary skill in the art to which the present invention pertains may modify the present invention in various ways from the above description. Accordingly, the spirit of the present invention should not be construed as being limited to the embodiments, and not only the claims to be described later, but also all equal or equivalent modifications thereof should be constructed as belonging to the category of a spirit of the present invention.

The present invention relates to a treemap visualization system and method, and more specifically, to a system and method, in which a user is allowed to control a three-dimensional treemap which is visualized by emphasizing a hierarchical structure, without distortion of a node size

To this end, a treemap visualization system in accordance with an embodiment of the present invention includes a raw data receiving unit, a node region forming unit and a node region protrusion unit. The raw data receiving unit receives raw data configured of a plurality of hierarchical nodes respectively having a weight value. The node region forming unit forms node regions positioned on a curved convex surface in correspondence to respective nodes. The node region protrusion unit determines protrusion directions of node regions so that the node regions may not overlap with each other and protrudes the node regions by moving the node regions in parallel in the determined protrusion directions.

What is claimed is:

1. A treemap visualization system, comprising a processor configured to:
receive raw data configured of a plurality of hierarchical nodes respectively having a weight value;
form node regions respectively corresponding to the nodes on a curved convex surface;
determine protrusion directions of the node regions so that the node regions may not overlap with each other; and
protrude the node regions by moving the node regions in parallel in the determined protrusion directions.

2. The visualization system of claim 1, wherein the processor is further configured to:
form the node regions such that a node region of a parent node includes node regions of child nodes, and;
protrude the node region of the parent node and the node regions of the child nodes of the parent node.

3. The visualization system of claim 1, wherein the processor is further configured to:
determine an area occupied by the node region of each node on the curved surface to correspond to a weight value of the node; and
form a node region to have the determined area.

4. The visualization system of claim 1, wherein the processor is further configured to:
form reference points respectively corresponding to child nodes of a root node on the curved surface; and
arrange the node regions such that a region of an area corresponding to a weight value of each node may be dynamically formed based on each reference point.

5. The visualization system of claim 4, wherein the processor is further configured to:
form reference points respectively corresponding to child nodes of each of the nodes, for which a node region is formed on the curved surface, within the node region of each of the nodes, i.e., a parent node; and
arrange node regions such that a region of an area corresponding to a weight value of each of the child nodes may be dynamically formed based on each reference point.

6. The visualization system of claim 1, wherein the processor is further configured to:
form a side surface of the node region moved in parallel; and
display node information corresponding to the node region on the side surface.

7. A treemap control system comprising, a processor configured to:
receive raw data configured of a plurality of hierarchical nodes respectively having a weight value;
output a three-dimensional treemap which protrudes node regions respectively corresponding to the nodes on a curved convex surface;
store attribution information of the nodes contained in the raw data in a database;
receive an interaction signal from a user;
determine an interaction function corresponding to the stored attribute information and the interaction signal input; and
transform the output three-dimensional treemap according to the determined function.

8. The control system of claim 7, wherein the interaction function includes a moving-to region-of-interest function set in correspondence to an interaction signal for moving to a region-of-interest in the three-dimensional treemap and a node control function set in correspondence to an interaction signal for controlling a node selected by the user, and the processor is further configured to:
determine a function corresponding to an interaction signal for moving to a region-of-interest based on the set moving-to region-of-interest function; and
determine a function corresponding to an interaction signal of the selected node based on the set node control function.

9. The control system of claim 8, wherein the processor is further configured to:
select a plurality of nodes based on the set moving-to region-of-interest function and then determines a function corresponding to an interaction signal for selecting a region-of-interest from the three-dimensional treemap based on the selected node; and
position the selected region-of-interest at a center of a display screen according to the determined function.

10. The control system of claim 8, wherein the processor is further configured to:
determine a function corresponding to an interaction signal for determining protrusion and depression of one or more selected node regions based on the set node control function; and
protrude or depress the selected node regions according to the determined function.

11. The control system of claim 8, wherein the processor is further configured to:
determine a function corresponding to an interaction signal for highlighting one or more nodes having same level or same attribute information as that of a selected node based on the set node control function and attribute information of the nodes; and
highlight the nodes having the same level or attribute information according to the determined function.

12. The control system of claim 8, wherein the processor is further configured to:
determine a function corresponding to an interaction signal for adjusting position and height of one or more selected nodes based on the set node control function and attribute information of the nodes; and
change the position and height of the selected nodes according to the determined function.

13. A treemap visualization method comprising:
(a) receiving, by a processor, raw data configured of a plurality of hierarchical nodes respectively having a weight value;
(b) forming, by the processor, node regions respectively corresponding to the nodes on a curved convex surface;
(c) determining, by the processor, protrusion directions of the node regions so that the node regions may not overlap with each other; and
(d) protruding, by the processor, the node regions by moving the node regions in parallel in the determined protrusion directions.

14. The visualization method of claim 13, wherein at step (b), the node regions are formed such that a node region of a parent node includes node regions of child nodes, and at step (d), the node region of the parent node and the node regions of the child nodes of the parent node are protruded.

15. The visualization method of claim 13, wherein at step (b), an area occupied by the node region of each node is determined on the curved surface to correspond to a weight value of the node, and a node region is formed to have the determined area.

16. The visualization method of claim 13, wherein step (b) includes:
forming, by the processor, reference points respectively corresponding to child nodes of a root node on the curved surface; and
arranging, by the processor, the node regions such that a region of an area corresponding to a weight value of each node may be dynamically formed based on each reference point.

17. The visualization method of claim 16, wherein step (b) includes:
forming, by the processor, reference points respectively corresponding to child nodes of each of the nodes, for which a node region is formed on the curved surface, within the node region of each of the nodes, i.e., a parent node; and
arranging, by the processor, node regions such that a region of an area corresponding to a weight value of each of the child nodes may be dynamically formed based on each reference point.

18. The visualization method of claim 13, further comprising:
forming, by the processor, a side surface of the node region moved in parallel; and
displaying, by the processor, node information corresponding to the node region on the side surface.

19. A treemap control method comprising:
(a) receiving, by a processor, raw data configured of a plurality of hierarchical nodes respectively having a weight value and outputting a three-dimensional treemap which protrudes node regions respectively corresponding to the nodes on a curved convex surface;
(b) storing, by the processor, attribution information of the nodes contained in the raw data;
(c) receiving, by the processor, an interaction signal from a user;
(d) determining, by the processor, an interaction function corresponding to the stored attribute information and the interaction signal input; and
(e) transforming, by the processor, the output three-dimensional treemap according to the determined function.

20. The control method of claim 19, wherein the interaction function includes a moving-to region-of-interest function set in correspondence to an interaction signal for moving to a region-of-interest in the three-dimensional treemap and a node control function set in correspondence to an interaction signal for controlling a node selected by the user, and
at step (e), a function corresponding to an interaction signal for moving to a region-of-interest is determined based on the set moving-to region-of-interest function, and a function corresponding to an interaction signal of the selected node is determined based on the set node control function.

21. The control method of claim 20, wherein at step (d), a plurality of nodes is selected based on the set moving-to region-of-interest function, and then a function corresponding to an interaction signal for selecting a region-of-interest from the three-dimensional treemap is determined based on the selected node, and at step (e), the selected region-of-interest is positioned at a center of a display screen according to the determined function.

22. The control method of claim 21, wherein at step (d), a function corresponding to an interaction signal for determining protrusion and depression of one or more selected node regions is determined based on the set node control function, and at step (e), the selected node regions are protruded or depressed according to the determined function.

23. The control method of claim 21, wherein at step (d), a function corresponding to an interaction signal for highlighting one or more nodes having same level or same attribute information as that of a selected node is determined based on the set node control function and attribute information of the nodes, and at step (e), the nodes having the same level or attribute information are highlighted according to the determined function.

24. The control method of claim 21, wherein at step (d), a function corresponding to an interaction signal for adjusting position and height of one or more selected nodes is determined based on the set node control function and attribute information of the nodes, and at step (e), the position and height of the selected nodes are changed according to the determined function.
